(19) United States
(12) Patent Application Publication
(10) Pub. No.: US 2014/0059669 A1
(43) Pub. Date: Feb. 27, 2014

(54) METHOD AND MOBILE TERMINAL FOR ENHANCING THE SECURITY OF A MOBILE TERMINAL

(71) Applicant: Tencent Technology (Shenzhen) Company Limited, Shenzhen (CN)

(72) Inventors: Can Cai YUAN, Shenzhen (CN); Sen Sheng XU, Shenzhen (CN); Ru Lan LIN, Shenzhen (CN); Lei LONG, Shenzhen (CN)

(73) Assignee: Tencent Technology (Shenzhen) Company Limited, Shenzhen (CN)

(21) Appl. No.: 14/042,577

(22) Filed: Sep. 30, 2013

Related U.S. Application Data
(63) Continuation of application No. PCT/CN2013/082137, filed on Aug. 23, 2013.

(30) Foreign Application Priority Data
Aug. 24, 2012 (CN) 201210305285.0

(51) Int. Cl. G06F 21/60

(52) U.S. Cl. CPC G06F 21/60
USPC 726/17

(57) ABSTRACT

The present disclosure discloses a method and mobile terminal for enhancing mobile terminal security, and relates to the information security field. The method includes: a mobile terminal providing in advance a target list to a user, setting at least one user-selected target from the list to a hidden state, and storing a password for a protected space set by the user, monitoring a specified application for the user to enter the password for the protected space, when detecting the user entering the password for the protected space via the specified application, entering the protected space, and restoring the target from a hidden state to a visible state, wherein the target can be an application/file at the mobile terminal. The mobile terminal can include: a setting module and a controlling module. The present disclosure can greatly enhance the security of the applications/documents at the mobile terminal.

### CROSS REFERENCE TO RELATED APPLICATION

This application is a U.S. continuation application under 35 U.S.C. §111(a) claiming priority under 35 U.S.C. §§120 and 365(c) to International Application No. PCT/CN2013/082137 filed Aug. 23, 2013, which claims the priority benefit of Chinese Patent Application No. 201210305285.0, filed on Aug. 24, 2012, the contents of both the PCT application and Chinese application are incorporated by reference herein in their entirety for all purposes.

### FIELD

The present disclosure relates to the field of information security, and in particular, to a method and mobile terminal for enhancing the security of a mobile terminal.

### BACKGROUND

Typically, a mobile terminal can be installed with many types of application programs and also store many types of files. To improve the security of the application programs and files at the mobile terminal, an encryption method can be utilized. Currently, there are two types of encryption methods: password encryption and algorithmic encryption. Password encryption can refer to setting passwords for the application programs and files at the mobile terminal. To use an application program or a file, the input of a correct preset password is required. Algorithmic encryption can refer to encrypting a file using a specified algorithm to generate a new file, for example, using MD5 (Message-Digest Algorithm 5) to generate an MD5 information abstract, and then restoring the original file from the new file using a corresponding algorithm.

However, using the above-described two types of encryption methods, the application programs and the files may have points of entries that can be explored by an unauthorized user to obtain their passwords using various methods. There can be great hidden security risks for the application programs and the files once their passwords are compromised.

### SUMMARY

To improve on the security of application programs and files at a mobile terminal, embodiments of the disclosure provide a method and mobile terminal for enhancing mobile terminal security. The technical solutions are as follows.

In a first aspect of the disclosure, a mobile device security-enhancing method is provided. The method can include the following exemplary steps.

A mobile terminal can provide in advance a target list to a user, set at least one user-selected target from the target list to a hidden state, and store a password for a protected space set by the user.

The mobile terminal can monitor a specified application for the user to enter the password for the protected space. When detecting the user entering the password for the protected space via the specified application, it can enter the protected space and restore the at least one target from the hidden state to a visible state.

The at least one target can include an application and/or file at the mobile terminal.

In another aspect, a mobile terminal can be provided. The mobile terminal can include the following exemplary modules.

A setting module that provides in advance a target list to a user, sets at least one user-selected target from the target list to a hidden state, and stores a password for a protected space set by the user.

A controlling module that monitors a specified application for the user to enter the password for the protected space, when detecting the user entering the password for the protected space via the specified application, enters the protected space, and restores the target from the hidden state to a visible state.

The at least one target can include an application and/or file at the mobile terminal.

In another aspect, a device can be provided. The device can include the following components: a processor, a display, and a memory unit that stores a program. The program which, when executed by the processor, can perform the following steps: maintaining a protected space in a first state, the protected space comprising at least one application or file, activating an application on the display in response to a user input, determining the entry, via the application, of a password that enables access to the protected space, and displaying the at least one application or file in the protected space on the display when a password that enables access to the protected space is entered.

The technical solutions provided in the embodiments of the disclosure can have the advantages including: the mobile terminal setting one or more targets selected by the user from the target list to a hidden state, and when detecting the user using a specified application to enter the password of the protected space, entering the protected space and restoring the target from a hidden state back to a visible state. This can achieve the effects of password-protecting one or more targets at the mobile terminal, and hide the user-selected targets to protect user privacy. Because the protected targets are not exposed at the mobile terminal, an unauthorized user is not able to view any of the protected content and, thus, it would be difficult for them to have thought about breaching the protection. As such, it can significantly enhance the security of the applications and files at the mobile terminal. In addition, the user is only required to enter the password of the protected space to use the protected applications and files. After entering the protected space, the user can use the applications and files very easily in a normal fashion, without any hindrance.

### BRIEF DESCRIPTION OF THE DRAWINGS

To better explain the technical solutions in the embodiments of the disclosure, the figures discussed in the following embodiments are briefly introduced. It should be understood that the figures described below correspond to only some of the embodiments and that other figures can be derived from these figures.

FIG. 1 is a flowchart illustrating the exemplary steps in a mobile terminal security enhancing method, according to an embodiment of the disclosure.

FIG. 2 is a flowchart illustrating the exemplary steps of a mobile terminal security enhancing method, according to another embodiment of the disclosure.

FIG. 3 is a block diagram illustrating the exemplary structure of a mobile terminal, according to an embodiment of the disclosure.

FIG. 4 is a block diagram illustrating the exemplary structure of a mobile terminal, according to another embodiment of the disclosure.

FIG. 5 illustrates exemplary common components of a computing system such as the mobile device in the various embodiments.

### DETAILED DESCRIPTION

A detailed description of the technical solutions of the embodiments of the present disclosure is provided below in view of the accompanying drawings. It should be understood that the embodiments described below are representative embodiments of the present disclosure rather than a complete disclosure of the every possible embodiment. The present disclosure can also include any other embodiments that can be derived from these disclosed embodiments by a person with ordinary skill in the art without any additional inventive work. It is to be understood that other embodiments can be used and structural changes can be made without departing from the scope of the embodiments of this disclosure.

In general, this relates to methods and systems for providing enhanced security to applications and files stored in an electronic device. As referred hereinafter, a terminal or device can be any electronic device capable of hosting application programs and store data. Such terminal or device can include, but are not limited to, PCs, Macs, desktop computers, laptop computers, tablet PCs, smartphones including iPhones, Android phones, Windows phones, and Blackberries, e-readers, in-car communication devices, televisions, gaming consoles and other consumer electronic devices. The terms “terminal” and “device” can be interchangeable terminologies. Although the term “mobile terminal” is used throughout the embodiments discussed below, it should be understood that mobile terminals are only an exemplary type of devices capable of utilizing these embodiments and that the embodiments are not limited to only mobile terminals. Furthermore, an application program as referred hereinafter can be any software program/application running on the device. A file can be any types of file stored temporarily or permanently in any of the internal or external storage devices associated with the device.

To enhance security of one or more of the application programs and/or files on the device such as a mobile terminal, the embodiments can provide a protected space that can be invisible from the user interface of the device. The protected space can be a virtual space on the device where application programs and files can be placed to for added security. In operation, the protected space can be implemented as a folder, directory, or any other suitable file structure. Application programs and files can be added into the protected space and removed from it. The protected space can be invisible when the device is in normal operation (e.g., when the device is first turned on). That is, the protected space is not represented by or associated with, for example, any icons, soft or physical buttons or keys on the device. It may also not be accessible using other regular input means such as voice activation or visible in any system tools, control panels, etc.

In some embodiment, a password can be required to access the protected space. Preferably, the password may be required to be entered through, for example, an application or interface on the device that is not apparently associated with the protected space. The application can have its original function. However, they can also be programmed to serve as an interface for entering the password for accessing the protected space. For example, an authorized user, who is aware of the protected space, can activate the calculator and enter the password using the keypad of the calculator. If the password is correct, the invisible protected space can visible to allow the user to access the files and applications in the space.

Because unauthorized users have no way of knowing which of these applications also serve as the interface for inputting the password to access the protected space, it can be highly unlikely and difficult for unauthorized users to try to break into the protected space. In fact, anyone other than the device owner or the person setting up the protected space may not even be aware of the existence of the protected space. This can provide an enhanced level of security to the applications and files in the protected space.

Once the protected space becomes visible, the user can add, remove, modify, and/or use the files and/or applications in the protected space in any suitable way. The user can leave the protected space by manually clicking on a hiding button displayed on the screen. Alternatively, the device can automatically exit the protected space after a predetermined period of time during which no activity in the space has been detected.

Referring to FIG. 1, an embodiment of the disclosure can provide a method of enhancing the security of a mobile terminal. The method can include the following exemplary steps.

101: a mobile terminal providing in advance a target list to a user, setting at least one user-selected target from the target list to a hidden state, and storing a password for a protected space set by the user.

102: monitoring a specified application for the user to enter the password for the protected space, when detecting the user entering the password for the protected space via the specified application, entering the protected space, and restoring the target from the hidden state to a visible state.

The target can be an application/file at the mobile terminal.

The above-described method of this embodiment can be implemented in software. When a mobile terminal is installed with this software, the user can set a password for the protected space in the software and select one or more targets to be protected. After the user finishes with the configuration, the software can hide the one or more user-selected targets and monitor a specified application to determine whether to enter the protected space and restore the targets to a visible state.

The protected space can refer to an environment for the user to use the one or more protected targets. By entering the password of the protected space, the user can enter the protected space. In the protected space, the protected targets can be visible, i.e., in a visible state. The user can use the protected targets. After exiting from the protected space, the targets designated by the user as hidden can be in a hidden state, to achieve the goal of protecting the protected targets.

The method provided in the above-described embodiment can set one or more targets selected by the user from the target list to a hidden state, and when detecting the user using a specified application to enter the password of the protected space, enter the protected space and restore the target previously set to a hidden state back to a visible state. This can achieve the effects of password-protecting the targets at the mobile terminal, and hiding the user-selected targets to protect user privacy. Because the protected targets are not exposed at the mobile terminal, an unauthorized user is not able to view any of the protected content and, thus, it would be difficult for them to have thought about breaching the protection. As such, it can significantly enhance the security of the applications and files at the mobile terminal. In addition, the user is only required to enter the password of the protected space to use the protected applications and files. After entering the protected space, the user can use the applications and files very easily in a normal fashion, without any hindrance.

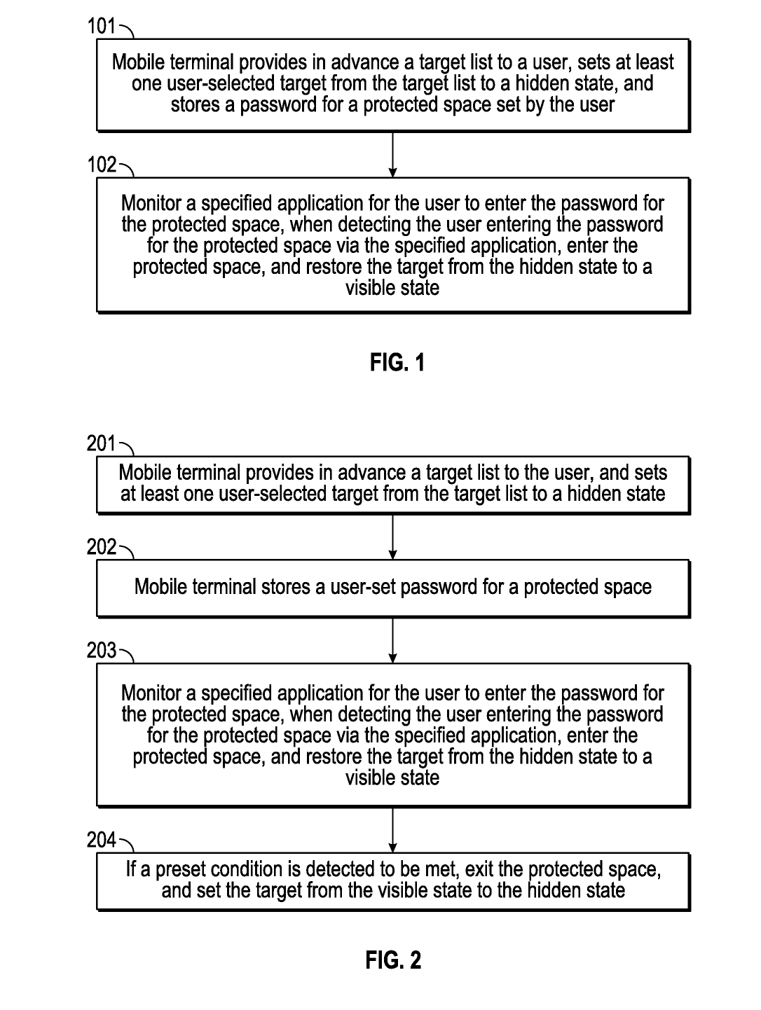

Referring to FIG. 2, another embodiment of the disclosure provides a method of enhancing the security of a mobile terminal. The method can include the following exemplary steps:

201: The mobile terminal can provide in advance a target list to the user, and set at least one user-selected target from the target list to a hidden state.

The target list can include, but is not limited to: an application list and/or file list. The target list can provide the user the one or more targets to be protected.

In particular, this step can further include the following steps.

The mobile terminal can provide in advance an application list to the user, the application list including at least one application installed at the mobile terminal; and/or the mobile terminal can provide in advance a file list to the user, the file list including at least one file stored at the mobile terminal.

The mobile terminal of this embodiment can be installed with multiple applications and store multiple files. The user can elect to protect one or more of the application as needed, and/or, the user can elect to protect one or more of the files. Typically, the application list provided by the mobile terminal can display all the applications installed at the mobile terminal. The user can arbitrarily select one or more of the applications. The file list provided by the mobile terminal can display all of the files stored at the mobile terminal. The user can arbitrarily select one or more of the files.

In this embodiment, the target can have two states: a hidden state and a visible state. The hidden state can refer to being hidden at any place at the mobile terminal. When the target is in a hidden state, it can mean that the target is in an invisible state at the mobile terminal. The user cannot see any entry point associated with the target. When the target is in a visible state, it can mean that the target is in a visible state at the mobile terminal. The user can see at least one entry point associated with the target. For example, the mobile terminal can be installed with a notebook. After being turned on, the display can display an icon of the notebook. The user can enter the notebook using the icon. When the notebook is hidden, the user cannot find the icon on the display interface, therefore cannot see the entry point of the notebook.

202: The mobile terminal can store a user-set password for a protected space.

In this embodiment, steps 201 and 202 do not have to be in a particular order. The disclosure does not intend to have any restrictions in this regard.

The user-set password for the protected space can include, but is not limited to, one or more numbers, letters, and/or symbols.

203: monitoring a specified application for the user to enter the password for the protected space, when detecting the user entering the password for the protected space via the specified application, entering the protected space, and restoring the target from the hidden state to a visible state;

In this embodiment, the specified application for the user to enter the password for the protected space can include, but is not limited to, at least one of the following: a numeric keypad, calculator, and search application. For example, the specified application can be a calculator. When the user activates the calculator and enters the password for the protected space in the calculator, the protected space can be entered.

When the user enters the protected spaces, the one or more hidden targets can be seen and thus the desired target can be activated and used.

204: if a preset condition is detected to be met, exiting the protected space, and setting the target from the visible state to the hidden state.

The predetermined condition can include, but is not limited to one of the following: the screen of the mobile terminal being locked, the activity-less period in the protected space exceeding a predetermined period of time, or the user clicking on a hiding button displayed on the screen. The disclosure does not have any restrictions in this regard.

In particular, this step can further include:

If a screen of the mobile terminal is locked, or the activity-less period in the protected space has exceeded a predetermined period of time, or the user clicks on a hiding button displayed on the screen, exiting the protected space, and setting the target from the visible state to the hidden state.

The predetermined period of time can be preset based on needs to, for example, three minutes or five minutes. The disclosure does not have any restrictions in this regard.

For example, after the user enters the protected space, activates a protected target, and stops operation after a period of time, it can then start counting time after the operation has stopped. When there has been no activity for a predetermined period of time, exiting the protected space, and setting the target from the visible state to the hidden state.

The screen locking of the mobile terminal can include the user manually locking the screen or the mobile terminal automatically locking the screen.

The hiding button can be displayed on the screen. When the user enters the protected space, the hiding button can be displayed on the screen. The disclosure does not have any restrictions with regard to the exact location for displaying the button. For example, it can be displayed at, for example, the top, left top corner, or right top corner of the screen. When the user needs to exit the protected space, he can click on the hiding button to exit the protected space and restore the protected targets to the hidden state.

In this embodiment, the user can change the setting of the protected targets at any time, including adding new protected targets and deleting protected targets, etc.

The method provided in the above-described embodiment can set one or more targets selected by the user from the target list to a hidden state, and when detecting the user using a specified application to enter the password of the protected space, enter the protected space and restore the target from the hidden state to a visible state. This can achieve the effects of password-protecting the targets at the mobile terminal, and hiding the user-selected targets to protect user privacy. Because the protected targets are not exposed at the mobile terminal, an unauthorized user is not able to view any of the protected content and, thus, it would be difficult for them to have thought about breaching the protection. As such, it can significantly enhance the security of the applications and files at the mobile terminal. In addition, the user is only required to enter the password of the protected space to use the protected applications and files. After entering the protected space, the user can use the applications and files very easily in a normal fashion, without any hindrance.

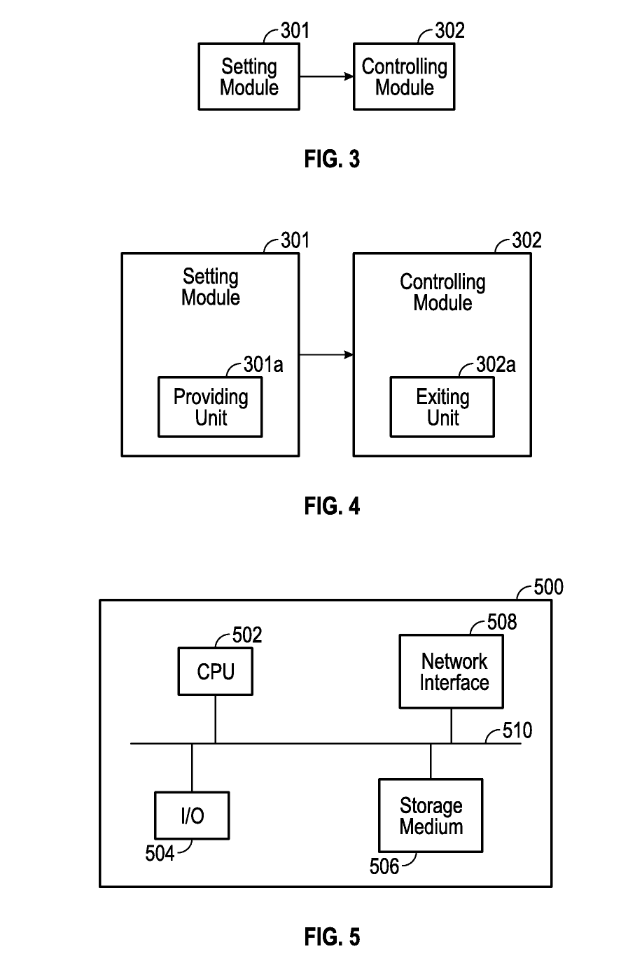

Referring to FIG. 3, another embodiment of the disclosure can provide a mobile terminal including the following exemplary modules.

A setting module 301 that can provide in advance a target list to a user, set at least one user-selected target from the target list to a hidden state, and store a password for a protected space set by the user.

A controlling module 302 that can monitor a specified application for the user to enter the password for the protected space, when detecting the user entering the password for the protected space via the specified application, enter the protected space, and restore the target from the hidden state to a visible state.

The target can be an application/file at the mobile terminal.

Referring to FIG. 4, in one embodiment, the setting module 301 can include the following unit.

A providing unit 301a that can provide in advance an application list to the user, the application list can include at least one application installed at the mobile terminal, and/or provide in advances a file list to the user, the file can include at least one file stored at the mobile terminal.

In another embodiment, the controlling module 302 can include the following exemplary unit.

An exiting unit 302a that, after the target is restored from the hidden state to the visible state, if a preset condition is detected to be met, exits the protected space, and sets the target from the visible state back to the hidden state.

In another embodiment, the exiting unit 302a can be used for:

After the target is restored from the hidden state to the visible state, if a screen of the mobile terminal is locked, or an activity-less period has exceeded a predetermined period of time, or the user clicks on a hiding button displayed on the screen, exiting the protected space, and setting the target from the visible state to the hidden state.

In this embodiment, the specified application for the user to enter the password for the protected space can include one of: a numeric keypad, calculator, and search application.

The method provided in the above-described embodiment can set one or more targets selected by the user from the target list to a hidden state, and when detecting the user using a specified application to enter the password of the protected space, entering the protected space and restore the target previously set to a hidden state back to a visible state. This can achieve the effects of password protecting the targets at the mobile terminal, and hide the user-selected targets to protect user privacy. Because the protected targets are not exposed at the mobile terminal, unauthorized users cannot view any of the protected content and, thus, it would be difficult for them to come up with a way to break the protection. As such, it can significantly improve the security of the applications and files at the mobile terminal. In addition, the user is only required to enter the password of the protected space to use the protected applications and files. After entering the protected space, the user can use the applications and files very easily in a normal fashion, without any hindrance.

In accordance with the above-described embodiments, a person skilled in the art can understand that parts of or the whole process described in each of the above embodiments can be performed by hardware in accordance with instructions from one or more computer programs. The one or more computer programs can be stored in a non-transitory readable medium, which can be read-only memory (ROM), a floppy disk, or a CD.

In some embodiments, one or more of the modules/units in FIGS. 3 and 4 can be stored and/or transported within any non-transitory computer-readable storage medium for use by or in connection with an instruction execution system, apparatus, or device, such as a computer-based system, processor-containing system, or other system that can fetch the instructions from the instruction execution system, apparatus, or device and execute the instructions. In the context of this file, a “non-transitory computer-readable storage medium” can be any medium that can contain or store the program for use by or in connection with the instruction execution system, apparatus, or device. The non-transitory computer readable storage medium can include, but is not limited to, an electronic, magnetic, optical, electromagnetic, infrared, or semiconductor system, apparatus or device, a portable computer diskette (magnetic), a random access memory (RAM) (magnetic), a read-only memory (ROM) (magnetic), an erasable programmable read-only memory (EPROM) (magnetic), a portable optical disc such a CD, CD-R, CD-RW, DVD, DVD-R, or DVD-RW, or flash memory such as compact flash cards, secured digital cards, USB memory devices, memory sticks, and the like.

The non-transitory computer readable storage medium can be part of a computing system serving as the mobile terminals or devices of the above-described embodiments of the disclosure. FIG. 5 illustrates exemplary common components of one such computing system. As illustrated, the system 500 can include a central processing unit (CPU) 502, I/O components 504 including, but not limited to one or more of display, keypad, touch screen, speaker, and microphone, storage medium 506 such as the ones listed in the last paragraph, and network interface 508, all of which can be connected to each other via a system bus 510. The storage medium 506 can include the modules/units of FIGS. 3 and 4.

The above description presents only a relatively preferred embodiment of the present invention, and does not mean to restrict this invention. Any modification, equivalent replacement, improvement made on the basis of the spirit and principle of the present invention shall be included in the scope of protection for the present invention.

What is claimed is:

1. A mobile terminal security enhancing method, comprising:
a mobile terminal providing in advance a target list to a user, setting at least one user-selected target from the target list to a hidden state, and storing a password for a protected space set by the user,
monitoring a specified application for the user to enter the password for the protected space, when detecting the user entering the password for the protected space via the specified application, entering the protected space, and restoring the at least one target from the hidden state to a visible state,
wherein the at least one target comprises an application and/or file at the mobile terminal.

2. The method of claim 1, wherein the mobile terminal providing in advance a target list to the user comprises:
the mobile terminal providing in advance an application list to the user, the application list comprising at least one application installed at the mobile terminal, and/or
the mobile terminal providing in advance a file list to the user, the file list comprising at least one file stored at the mobile terminal.

3. The method of claim 1, comprising: after restoring the target from the hidden state to the visible state:
if a preset condition is detected to be met, exiting the protected space, and setting the at least one target from the visible state to the hidden state.

4. The method of claim 3, wherein, if the preset condition is detected to be met, exiting the protected space and setting the target from the visible state to the hidden state comprises:
if a screen of the mobile terminal is locked, an activity-less period in the protected space exceeds a predetermined period of time, or the user clicks on a hiding button displayed on the screen, exiting the protected space and setting the target from the visible state to the hidden state.

5. The method of claim 1, wherein the specified application for the user to enter the password for the protected space comprises one of: a numeric keypad, calculator, and search application.

6. A mobile terminal comprising:
a setting module that provides in advance a target list to a user, sets at least one user-selected target from the target list to a hidden state, and stores a password for a protected space set by the user,
a controlling module that monitors a specified application for the user to enter the password for the protected space, when detecting the user entering the password for the protected space via the specified application, enters the protected space, and restores the target from the hidden state to a visible state,
wherein the at least one target comprises an application and/or file at the mobile terminal.

7. The mobile terminal of claim 6, wherein the setting module comprises:
a providing unit that provides in advance an application list to the user, the application list comprising at least one application installed at the mobile terminal, and/or provides in advance a file list to the user, the file list comprising at least one file stored at the mobile terminal.

8. The mobile terminal of claim 6, wherein the controlling module comprises:
an exiting unit that, after the target is restored from the hidden state to the visible state, if a preset condition is detected to be met, exits the protected space and sets the target from the visible state to the hidden state.

9. The mobile terminal of claim 8, wherein the exiting unit, after the target is restored from the hidden state to the visible state, if a screen of the mobile terminal is locked, or an activity-less period in the protected space exceeds a predetermined period of time, or the user clicks on a hiding button displayed on the screen, exits the protected space, and sets the target from the visible state to the hidden state.

10. The mobile terminal of claim 6, wherein the specified application for the user to enter the password for the protected space comprises one of: a numeric keypad, calculator, or a search application.

11. A device comprising:
a processor,
a display, and
a memory unit that stores a program which, when executed by the processor, performs the steps of:
maintaining a protected space in a first state, the protected space comprising at least one application or file,
activating an application on the display in response to a user input,
determining the entry, via the application, of a password that enables access to the protected space, and
displaying the at least one application or file in the protected space on the display when a password that enables access to the protected space is entered.

12. The device of claim 11, wherein the first state comprises an invisible state.

13. The device of claim 11, wherein the activated application is apparently unrelated to the protected space.

14. The device of claim 11, wherein the at least one application or file in the protected space is selected in response to user input from a target list.

15. The device of claim 11, wherein the application comprises at least one of a calculator, a search application, and a numeric keypad.

16. The device of claim 11, wherein the program which, when executed by the processor, performs the steps of:
determining whether a condition for exiting the protected space is detected, and
removing the protected space from the display.

17. The device of claim 16, wherein the condition for exiting the protected space comprises at least one of: the device being locked, an activity-less period in the protected space having exceeded a defined period of time, and a user clicking on a hiding button displayed on the screen.

18. The device of claim 17, wherein the activity-less period starts from an end of a prior user operation detected in the protected space.

19. The device of claim 17, wherein the program which, when executed by the processor, performs the steps of:
configuring the protected space by performing at least one of setting the password associated with the protected space, adding an application or file to the protected space, and removing an application or file from the protected space.

20. The device of claim 19, wherein the program which, when executed by the processor, performs the steps of:
when an application or file is added to the protected space, enabling invisibility of the application or file unless the protected space is accessed.
